(19) United States
(12) Patent Application Publication
(10) Pub. No.: US 2025/0390222 A1
(43) Pub. Date: Dec. 25, 2025

(54) MEMORY BANK BUFFERING OF COMMANDS

(71) Applicant: Micron Technology, Inc., Boise, ID (US)

(72) Inventors: Venkata Kiran Kumar Matturi, Milpitas, CA (US); Sharath Chandra Ambula, Mancherial (IN)

(21) Appl. No.: 19/234,219

(22) Filed: Jun. 10, 2025

Related U.S. Application Data
(60) Provisional application No. 63/662,933, filed on Jun. 21, 2024.

(51) Int. Cl. G06F 3/06

(52) U.S. Cl. CPC G06F 3/0611; G06F 3/0656; G06F 3/0673

(57) ABSTRACT

Methods, systems, and devices for memory bank buffering of commands are described. Memory banks of a memory system may buffer commands that may be received out of order relative to a command sequence. For example, a memory system may receive an activate command associated with a memory bank prior to receiving a precharge command, and may store the activate command in a buffer of the memory bank. The memory system may receive the precharge command and perform a precharge operation on the memory bank. After completing the precharge operation, the memory system may access the stored activate command from the buffer of the memory bank and utilize the activate command to perform an activation operation on the memory bank. Thus, the memory system may perform commands according to the command sequence when the memory bank is available to perform them rather than waiting for specific commands to be resent.

### CROSS REFERENCE

The present Application for Patent claims priority to U.S. Patent Application No. 63/662,933 by Matturi et al., entitled “MEMORY BANK BUFFERING OF COMMANDS,” filed Jun. 21, 2024, which is assigned to the assignee hereof, and which is expressly incorporated by reference in its entirety herein.

### TECHNICAL FIELD

The following relates to one or more systems for memory, including memory bank buffering of commands.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports memory bank buffering of commands in accordance with examples as disclosed herein.

FIG. 2 shows an example of an architecture that supports memory bank buffering of commands in accordance with examples as disclosed herein.

FIG. 3 shows an example of a timing diagram that supports memory bank buffering of commands in accordance with examples as disclosed herein.

FIG. 4 shows a block diagram of a memory system that supports memory bank buffering of commands in accordance with examples as disclosed herein.

FIG. 5 shows a flowchart illustrating a method or methods that support memory bank buffering of commands in accordance with examples as disclosed herein.

### DETAILED DESCRIPTION

Some memory systems (e.g., dynamic random access memory (DRAM) systems) may utilize command/address (CA) busses to communicate commands and address information between memory devices and other components of the memory system (e.g., or coupled with the memory system, such as a host system). Traditionally, commands may be communicated via a CA bus in a specific order. For example, to access a memory bank of the memory system, the memory system may receive a precharge command associated with the memory bank via the CA bus. After receiving the precharge command (e.g., after a duration), the memory system may receive an activate command associated with the memory bank. The memory system may activate the memory bank in response to receiving the activate command. After receiving the precharge command and the activate command, the memory system may receive a read command to read the memory bank. In some examples the memory system may be required to perform operations associated with the memory banks in a particular sequence (e.g., order) and according to a specific timeline, which may result in latency as the memory system may wait to receive commands that align with the sequence (e.g., the internal operations may be waiting on commands via the CA bus).

To decrease latency in a memory system, memory banks of the memory system may buffer commands that may be received out of order (e.g., relative to a specific command sequence). For example, a memory system may receive an activate command associated with a memory bank prior to receiving a precharge command, and may store the activate command in a buffer of the memory bank. The memory system may then receive the precharge command and perform a precharge operation on the memory bank. Upon completing the precharge operation, the memory system may automatically access the stored activate command from the buffer of the memory bank and utilize the activate command to perform an activation operation on the memory bank. Thus, the memory system may perform commands according to the sequence when the memory bank is available to perform them, which may decrease wait times associated with reception of the commands and reduce overall latency of the memory system.

In addition to applicability in memory systems as described herein, techniques for buffering commands at memory banks may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds, which may decrease processing or latency times, improve response times, or otherwise improve user experience, among other benefits.

In addition to applicability in memory systems and high-performance applications as described herein, techniques for buffering commands at memory may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by reducing a quantity of operations performed by electronic devices, which may extend the life of electronic devices and thereby reducing electronic waste, among other benefits.

Features of the disclosure are illustrated and described in the context of systems and architectures. Features of the disclosure are further illustrated and described in the context of timing diagrams and flowcharts.

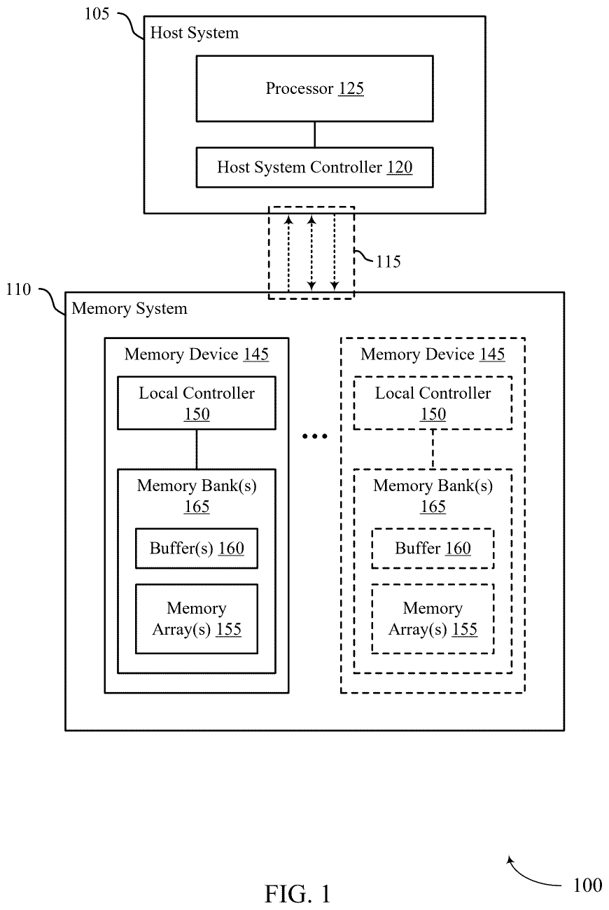

FIG. 1 illustrates an example of a system 100 that supports memory bank buffering of commands in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, one or more processing components) that use memory to execute processes, any one or more of which may be referred to as or be included in a processor 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

The host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or some combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include one or more memory devices 145 (e.g., memory packages, memory dies, memory chips) operable to store data. The memory system 110 may be configurable for operations with different types of host systems 105, and may respond to commands from the host system 105 (e.g., from a host system controller 120). For example, the memory system 110 may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations. The host system 105 may individually address memory devices 145 (e.g., via separate channels 115), or may communicate with memory devices 145 via a shared set of channels 115 (e.g., using chip select (CS) or other signals for selecting one or more of memory devices 145 for memory commands).

Each memory device 145 may include a local controller 150 and one or more memory banks 165. Each of the memory banks 165 may include one or more memory arrays 155, which may be a collection of memory cells (e.g., a two-dimensional array, a three-dimensional array), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include one or more components (e.g., circuitry, logic, instructions) operable to control operations of a memory device 145. In some examples, a local controller 150 may be operable to implement instructions received at a memory device 145, and may perform functions such as address decoding or controlling timing for memory operations. For example, a local controller 150 may include decoding components operable for accessing addresses of a memory array 155, or various other components operable for supporting described operations of a memory system 110.

Each of the memory banks 165 may also include one or more buffers 160. Each of the buffers 160 may temporarily store commands associated with various access operations of the memory banks 165. In some examples, the memory system may store various commands that may be received out of order (e.g., relative to a sequence of commands) to the buffers 160. The memory system buffers 160 may be enabled to store the out-of-order commands until the memory system accesses the commands to be used in operations associated with the memory banks 165 and according to the sequence of commands. In some examples, each of the memory banks 165 may include one buffer 160, while in other cases each of the memory banks 165 may include multiple buffers 160. Additionally, or alternatively, a buffer 160 may be located at another place within the memory system (e.g., outside the memory banks 165).

A host system 105 (e.g., a host system controller 120) and a memory system 110 may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. To support communications over channels 115, a host system 105 (e.g., a host system controller 120) and a memory system 110 may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

Signaling may be communicated over the channels 115 using single data rate (SDR) signaling or double data rate (DDR) signaling, among other rates (e.g., relative to a clock signal). In SDR signaling, one modulation symbol (e.g., signal level) of a signal may be registered for each clock cycle (e.g., on a rising edge or a falling edge of a clock signal). In DDR signaling, two modulation symbols of a signal may be registered for each clock cycle (e.g., on both a rising edge and a falling edge of a clock signal).

The memory system 110 (e.g., a dynamic random access memory (DRAM) system) may utilize CA busses (e.g., the channels 115) to communicate commands between the memory devices 145 and other components of the memory system 110 (e.g., or coupled with the memory system 110, such as the host system 105). Traditionally, commands may be communicated via a CA bus in a specific order. For example, to access a memory bank 165 of the memory system 110, the host system 105 may transmit and the memory system 110 may receive a precharge command associated with the memory bank 165 via the CA bus. After receiving the precharge command (e.g., after a duration), the memory system 110 may receive an activate command associated with a row of the memory bank 165. The memory system 110 may activate the row of the memory bank 165 in response to receiving the activate command. After receiving the precharge command and the activate command, the memory system 110 may receive a read command to read the row of the memory bank 165. Subsequent to reading the row of the memory bank 165, the memory system 110 may receive a precharge command to close (e.g., deactivate) the row of the memory bank 165. In some examples the memory system 110 may be required to perform operations associated with the memory banks 165 in a particular sequence (e.g., order) and according to a specific timeline, which may result in latency as the memory system 110 may wait to receive commands that align with the sequence (e.g., the internal operations may be waiting on commands via the CA bus).

To decrease latency in the memory system 110, the memory banks 165 of the memory system 110 may buffer commands that may be received out of order (e.g., relative to a specific command sequence). For example, the memory system 110 may receive an activate command associated with a memory bank 165 prior to receiving a precharge command, and may store the activate command in the buffer 160 of the memory bank 165. The memory system 110 may then receive the precharge command and perform a precharge operation on the memory bank 165. After completing the precharge operation, the memory system 110 may automatically access the stored activate command from the buffer 160 of the memory bank 165 and utilize the activate command to perform an activation operation on the memory bank 165. Thus, the memory system 110 may perform commands according to the sequence when the memory bank 165 is available to perform them, which may decrease wait times associated with reception of the commands and reduce overall latency of the memory system 110.

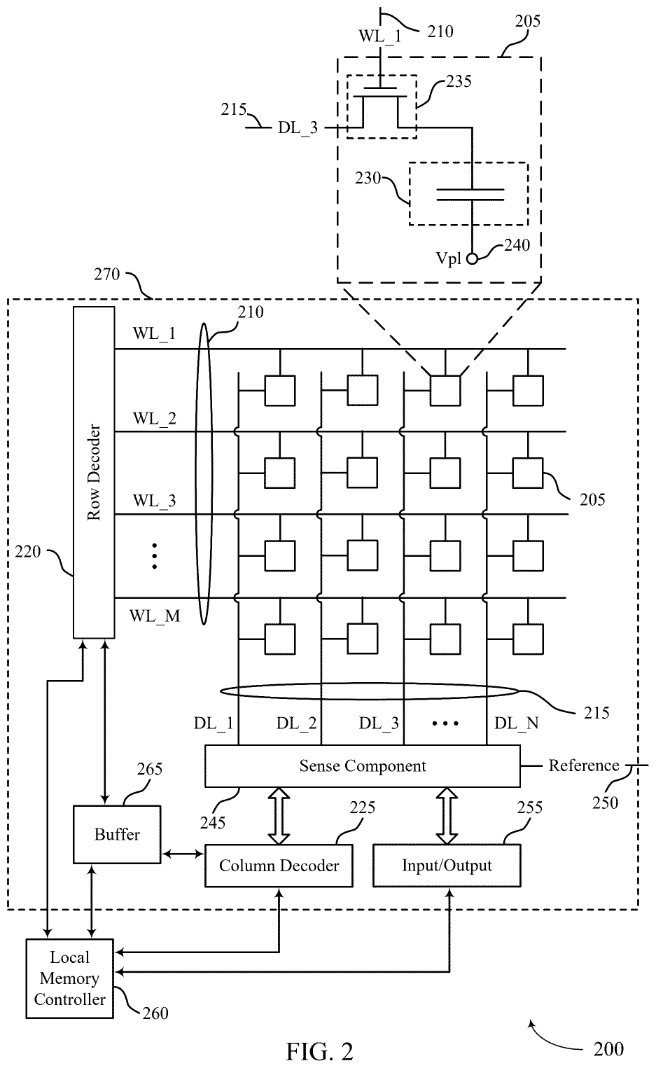

FIG. 2 illustrates an example of an architecture 200 (e.g., a memory architecture) that supports memory bank buffering of commands in accordance with examples as disclosed herein. The architecture 200 may be implemented in a memory system 110 or one or more components thereof (e.g., memory device 145). Aspects of the architecture 200 may be referred to as or implemented in a semiconductor component, such as a memory die.

The architecture 200 may include a memory bank 270, which may be an example of a memory bank 165 as described with reference to FIG. 1. The memory bank 270 may include one or more memory cells 205, one or more access lines (e.g., word lines 210, digit lines 215), a sense component 245, a column decoder 225, a row decoder 220, one or more buffers 265, among other components. In some examples, an associated memory system may access the memory bank 270 in response to one or more commands. For example, the memory system may receive a precharge command, and may precharge the one or more access lines of the memory bank 270 to prepare for accessing the memory bank 270. The memory system may receive an activate command to activate a row of the memory bank 270. In the case that the memory system has performed the precharge operation, the memory system may perform an activation operation based on the activate command to activate the row of the memory bank 270. The memory system may receive a read command to read the row of the memory bank 270. In the case that the memory system has performed the precharge and activate operations on the row of the memory bank 270, the memory system may perform a read operation based on the read command to read the row of the memory bank 270. In some cases, the memory system may perform operations according to a command sequence and, in some examples, the command sequence may include a precharge command, an activate command for a row, and a read command for the row (e.g., in this order or in another order).

The architecture 200 includes memory cells 205 that are programmable to store information. In some examples, a memory cell 205 may be operable to store one bit of information at a time (e.g., a logic 0 or a logic 1). In some examples, a memory cell 205 (e.g., a multi-level memory cell) may be operable to store more than one bit of information at a time (e.g., a logic 00, logic 01, logic 10, a logic 11). Memory cells 205 may be arranged in an array, such as in a memory array 155.

In the example of architecture 200, a memory cell 205 may include a storage component, such as capacitor 230, and a selection component 235 (e.g., a cell selection component, a transistor). A capacitor 230 may be a dielectric capacitor or a ferroelectric capacitor. A node of the capacitor 230 may be coupled with a voltage source 240, which may be a cell plate reference voltage, such as Vpl, or may be a ground voltage, such as Vss. A charge stored by a memory cell 205 (e.g., by a capacitor 230) may be representative of a programmed state. Other memory architectures that support the techniques described herein may implement different types or arrangements of storage components and associated circuitry (e.g., with or without a selection component).

The architecture 200 may include various arrangements of access lines, such as word lines 210 and digit lines 215. An access line may be a conductive line that is coupled with a memory cell 205, and may be used to perform access operations on the memory cell 205. Word lines 210 may be referred to as row lines, and digit lines 215 may be referred to as column lines or bit lines, among other nomenclature. Memory cells 205 may be positioned at intersections of access lines, and an intersection may be referred to as an address of a memory cell 205.

In some architectures, a word line 210 may be coupled with a gate of a selection component 235 of a memory cell 205, and may be operable to control (e.g., switch, modulate a conductivity of) the selection component 235. A digit line 215 may be operable to couple a memory cell 205 with a sense component 245. In some architectures, a memory cell 205 (e.g., a capacitor 230) may be coupled with a digit line 215 during portions of an access operation. For example, a word line 210 and a selection component 235 of a memory cell 205 may be operable to couple or isolate a capacitor 230 of the memory cell 205 with a digit line 215.

Operations such as reading and writing may be performed on memory cells 205 by activating (e.g., applying a voltage to) access lines such as a word line 210 or a digit line 215. Accessing the memory cells 205 may be controlled through a row decoder 220, or a column decoder 225, or a combination thereof. For example, a row decoder 220 may receive a row address (e.g., from a local memory controller 260) and activate a word line 210 based on a received row address, and a column decoder 225 may receive a column address and activate a digit line 215 based on a received column address. Selecting or deselecting a memory cell 205 may include activating or deactivating a selection component 235 using a word line 210. For example, a capacitor 230 may be isolated from a digit line 215 when the selection component 235 is deactivated, and the capacitor 230 may be coupled with the digit line 215 when the selection component 235 is activated.

A sense component 245 may be operable to detect a state (e.g., a charge) stored by a capacitor 230 of a memory cell 205 and determine a logic state of the memory cell 205 based on the stored state. A sense component 245 may include one or more sense amplifiers to amplify or otherwise convert a signal resulting from accessing the memory cell 205. The sense component 245 may compare a signal detected from the memory cell 205 with a reference 250 (e.g., a reference voltage). The detected logic state of the memory cell 205 may be provided as an output of the sense component 245 (e.g., via an input/output 255), and may indicate the detected logic state to another component of a memory system 110 that implements the architecture 200.

The local memory controller 260 may control the accessing of memory cells 205 through the various components (e.g., a row decoder 220, a column decoder 225, a sense component 245), and may be an example of or otherwise included in a local controller 150, or another controller of the memory system. In some examples, one or more of a row decoder 220, a column decoder 225, and a sense component 245 may be co-located with or included in the local memory controller 260. The local memory controller 260 may be operable to receive commands or data from one or more different controllers (e.g., a host system controller 120), translate the commands or the data into information that can be used by the architecture 200, initiate or control one or more operations of the architecture 200, and communicate data from the architecture 200 to a host (e.g., a host system 105) based on performing the one or more operations.

The local memory controller 260 may be operable to perform one or more access operations on one or more memory cells 205 of the architecture 200. Examples of an access operation may include a write operation, a read operation, a refresh operation, a precharge operation, or an activate operation, among others. In some examples, an access operation may be performed by or otherwise coordinated by the local memory controller 260 in response to one or more access commands (e.g., from a host system 105). The local memory controller 260 may be operable to perform other access operations not listed here or other operations related to the operating of the architecture 200 that are not directly related to accessing the memory cells 205.

To support an access operation, a local memory controller 260 may identify a target memory cell 205 on which to perform the access operation, which may be associated with identifying a target word line 210 and a target digit line 215 coupled with the target memory cell 205 (e.g., an address of the target memory cell 205). The local memory controller 260 may control activating the target word line 210 and the target digit line 215 to access the target memory cell 205. During a write operation, the local memory controller 260 may control the application of a signal (e.g., a write pulse, a write voltage) to the target digit line 215 to store a specific state (e.g., a charge, in a capacitor 230) of the memory cell 205. The signal used as part of the write operation may include one or more voltage levels applied to the target memory cell 205 (e.g., via the target digit line 215) over one or more respective durations. During a read operation, the target memory cell 205 may transfer a signal (e.g., charge, voltage) to the sense component 245 based on activating the target word line 210 and the target digit line. The local memory controller 260 may activate the sense component 245 (e.g., initiate latching a sense amplifier of the sense component 245), which may include comparing the signal transferred from the memory cell 205 to a reference (e.g., the reference 250). Based on the comparison, the sense component 245 may determine a logic state that is stored on the memory cell 205.

The memory bank 270 may include the buffer 265, which may be an example of the buffers 160 described with reference to FIG. 1. The buffers 265 may temporarily store commands associated with various access operations of the memory bank 270. In some examples, the memory system may store various commands that may be received out of order (e.g., relative to a sequence of commands used for operations on the memory bank 270) to the buffers 265. The memory system buffers 265 may be enabled to store the out-of-order commands until the memory system accesses the commands to be used in operations associated with the memory bank 270 and according to the sequence of commands. In some examples, each of the memory banks 270 may include one buffer 265, while in other cases each of the memory banks 270 may include multiple buffers 265. Additionally, or alternatively, a buffer 265 may be located at another place within the memory system (e.g., outside the memory bank 270).

A memory system (e.g., a DRAM system) may utilize CA busses to communicate commands between memory devices and other components of the memory system (e.g., or coupled with the memory system, such as a host system). Traditionally, commands may be communicated via a CA bus in a specific order. For example, to access a memory bank 270 of the memory system, the memory system may receive a precharge command associated with the memory bank 270 via the CA bus. After receiving the precharge command (e.g., a specified time duration after receiving the precharge command), the memory system may receive an activate command associated with a row of the memory bank 270. The memory system may activate the row (e.g., WL 210) of the memory bank 270 in response to receiving the activate command. After receiving the precharge command and the activate command, the memory system may receive a read command to read the row of the memory bank 270. Subsequent to reading the row of the memory bank 270, the memory system may receive a precharge command to close (e.g., deactivate) the row of the memory bank 270. In some examples the memory system may be required to perform operations associated with the memory banks 270 in a particular sequence (e.g., order) and according to a specific timeline, which may result in latency as the memory system may wait to receive commands that align with the sequence (e.g., the internal operations may be waiting on commands via the CA bus).

To decrease latency in the memory system, the memory banks 270 of the memory system may buffer commands that may be received out of order (e.g., relative to a specific command sequence). For example, a memory system may receive an activate command associated with a second row of a memory bank 270 prior to receiving a precharge command (e.g., while a first row is activated), and may store the activate command in the buffer 265 of the memory bank 270. The memory system may then receive the precharge command (e.g., subsequent to a read operation) and perform a precharge operation on the memory bank 270. After completing the precharge operation, the memory system may automatically access the stored activate command from the buffer 265 of the memory bank 270 and utilize the activate command to perform an activation operation on the second row of the memory bank 270. Thus, the memory system may perform commands according to the sequence when the memory bank is available to perform them, which may decrease wait times associated with reception of the commands and reduce overall latency of the memory system.

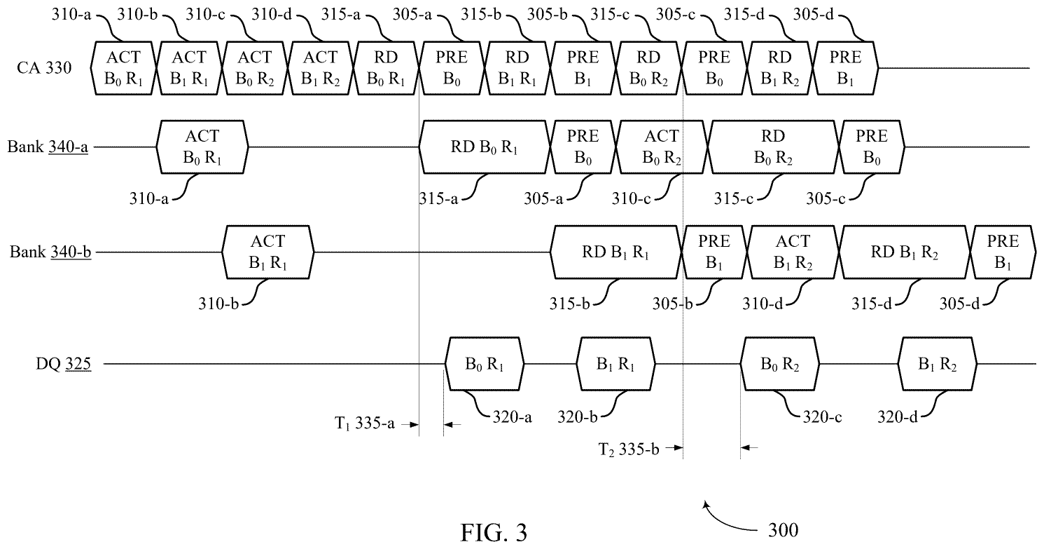

FIG. 3 shows an example of a timing diagram 300 that supports memory bank buffering of commands in accordance with examples as disclosed herein. The timing diagram 300 may be implemented in a memory system 110 or one or more components thereof (e.g., memory device 145), as described with reference to FIG. 1. The timing diagram 300 may also be implemented in or include examples of a memory bank 270, memory banks 165, a buffer 265, buffers 160, or a combination thereof, as described with reference to FIGS. 1 and 2. For example, the timing diagram 300 may include an example of a memory bank 340-a (e.g., a first memory bank, bank 0) and a memory bank 340-b (e.g., a second memory bank, bank 1). The timing diagram 300 may illustrate a stream of commands that may be received via the CA channels 330 coupled with the memory system. The CA channels 330 may be examples of the CA channels and CA busses described with reference to FIGS. 1 and 2. The timing diagram 300 may also include a DQ channel 325, which may be an example of a data channel as described with reference to FIG. 1.

A memory system may utilize CA busses (e.g., the CA channel 330) to communicate commands and address information between memory devices and other components of the memory system (e.g., or coupled with the memory system, such as a host system). Traditionally, commands may be communicated via the CA channel 330 in a specific order, as further discussed herein. For example, to access a memory bank of the memory system (e.g., a memory bank 165, a memory bank 270, a memory bank 340), the memory system may receive a precharge command associated with the memory bank via the CA channel 330. After receiving the precharge command, the memory system may receive an activate command associated with a row of the memory bank. The memory system may activate the row of the memory bank in response to receiving the activate command. After receiving the precharge command and the activate command, the memory system may receive a read command to read the row of the memory bank. Subsequent to reading the row of the memory bank, the memory system may receive a precharge command to close (e.g., deactivate) the row of the memory bank, such that a different row can be activated by a new activate command. In some examples the memory system may be required to perform operations associated with the memory banks in a particular sequence (e.g., order) and according to a specific timeline, which may result in latency as the memory system may wait to receive commands that align with the sequence (e.g., the internal operations may be waiting on commands via the CA channel 330).

To decrease latency in the memory system, the memory banks 340 of the memory system may buffer commands that may be received out of order (e.g., relative to a specific command sequence). For example, the memory system may receive one or more activate (ACT) commands 310, each associated with a row (e.g., R₁, R₂) of one of the memory banks 340 prior to receiving a precharge (PRE) command 305 (e.g., a precharge command that closes a currently open row) for each of the memory banks 340, and may store the activate commands 310 in buffers of each respective memory bank 340. The memory system may then receive one or more read commands 315 and the precharge commands 305, and may perform the read and precharge operations on each of the memory banks 340. After completing the precharge operation, the memory system may automatically access the stored activate commands 310 from the buffers of the memory banks 340 and utilize the activate commands 310 to perform an activation operation on each of the memory banks 340. After performing the precharge and activation operations, the memory system may utilize the read commands 315 to perform one or more read operations (e.g., on a different row) on the memory banks 340. Thus, the memory system may perform operations according to the command sequence when the memory banks 340 are available to perform them, which may decrease wait times associated with reception of the commands and reduce overall latency of the memory system.

The memory system may retrieve commands from the buffer according to the state of the memory bank and according to a priority of commands that depends on the state of the memory bank. For example, if the memory bank is precharged, the memory bank may pull activate commands in the order in which they were received. If a row is activated, the memory bank may pull access commands (e.g., read, write, refresh) for that row in the order in which they were received, until there are no more access commands, then may pull precharge commands.

The memory system may receive one or more commands associated with activating one or more rows of the memory banks 340 of a memory device of the memory system. During a valid time period of the CA channels 330, the memory system may receive one or more activate commands 310. For example, the memory system may receive an activate command 310-a for a first row (R₁) of the memory bank 340-a of the memory device. The activate commands may be a multiple-part commands (e.g., where each part may be associated with different bits of a row address), although for simplicity the activate commands are shown as one command. In some examples, the memory system may also receive an activate command 310-b for a first row (R₁) of the memory bank 340-b. The memory system may also receive an activate command 310-c for a second row (R₂) of the memory bank 340-a, and an activate command 310-d for a second row (R₂) of the memory bank 340-b. In some examples, the memory bank 340-a may be included in the same memory device as the memory bank 340-b.

In some examples, after receiving the one or more activate commands 310, the memory system may determine that one or more rows of the memory banks 340 may be precharged and may perform one or more of the received activate commands 310. For example, for the activate command 310-a, the memory system may determine that the memory bank 340-a may be precharged and available, and may perform an activation operation on the first row of the memory bank 340-a utilizing the activate command 310-a. The memory system may then determine that the memory bank 340-b may be precharged and available, and may perform an activation operation on the first row of the memory bank 340-b utilizing the activate command 310-b.

The memory system may determine one or more of the remaining activate commands 310 to be sent out of order (e.g., relative to the sequence of commands) and may store the activate commands 310 to a buffer of the associated memory banks 340. For example, the memory system may determine that the received activate command 310-c and activate command 310-d may have been sent (e.g., received) out of order relative to a specific command sequence (e.g., as described herein). The memory system may receive the activate command 310-c associated with the second row of the memory bank 340-a prior to receiving a precharge command 305-a associated with the same row (e.g., while the first row of the memory bank 340-a is activated). In response to determining that the activate command 310-c was sent out of sequence, the memory system may store the activate command 310-c to a buffer of the memory bank 340-a. The memory device may also determine the activate commands 310-d to be out of sequence, and may store the activate command 310-d to a buffer of the memory bank 340-b. The memory system may temporarily refrain from performing activation operations associated with the activate command 310-c and the activate command 310-d, as the activate command 310-c and the activate command 310-d were received out of order relative to the sequence of commands (e.g., the first rows of the memory banks 340 are still activated, or the memory banks 340 are not precharged).

The memory system may receive a read command 315 for an active row of the memory banks 340, and may perform a read operation. For example, the memory system may receive the read command 315-a for the first row of the memory bank 340-a. The memory system may determine the first row of the memory bank 340-a to be available and active (e.g., after performing the activation operation associated with the activate command 310-a), and may perform a read operation on the first row of the memory bank 340-a according to the read command 315-a. After a first duration T₁ 335-a associated with the read operations, the memory system may output the data 320-a from the first row of the memory bank 340-a via the DQ channel 325. In some examples, the memory system may scan the buffer of the memory bank 340-a to determine whether any other read commands associated with the first row of the memory bank 340-a may be stored. In the case that the memory system may determine that another read command is stored to the buffer and the row is still active, the memory system may perform another read operation according to the stored read command.

The memory system may receive one or more precharge commands 305. After receiving and storing (e.g., the buffer) the activate command 310-c, the memory system may receive a precharge command 305-a associated with the memory bank 340-a. In response to determining that the memory bank 340-a may be available for the precharge operation, the memory system may perform a precharge operation on the memory bank 340-a according to the precharge command 305-a (e.g., may deactivate the first row and precharge the bit lines).

In some examples, the memory system may also receive the read command 315-b for the first row of the memory bank 340-b. For example, the memory system may receive the read command 315-b for the first row of the memory bank 340-b. The memory system may determine the first row of the memory bank 340-b to be available and active (e.g., after performing the activation operation associated with the activate command 310-b), and may perform a read operation on the first row of the memory bank 340-b according to the read command 315-b. The memory system may output the data 320-b from the first row of the memory bank 340-b via the DQ channel 325.

The memory system may access the previously-stored activate commands 310 from the buffers of the memory blocks and perform an activation operation on the second row of the memory bank 340-a. For example, after performing the precharge operation associated with the precharge command 305-a on the memory bank 340-a, the memory system may determine that the next command in the command sequence (e.g., the command following the precharge command 305-a) may be the activate command 310-c. In response to determining the next command in the sequence of commands, and that the memory bank 340-a may be available, the memory system may trigger the accessing of the activate command 310-c from the buffer of the memory bank 340-a. The memory system may perform one or more activation operations on the memory banks. For example, after accessing the activate command 310-c stored to the buffer of the memory bank 340-a, the memory system may utilize the activate command 310-c to perform an activation operation on the second row of the memory bank 340-a.

The memory system may receive another precharge command 305. For example, the memory system may receive a precharge command 305-b associated with the second row of the memory bank 340-b. In response to determining that the memory bank 340-b may be available, the memory system may perform a precharge operation associated with the memory bank 340-b according to the precharge command 305-b.

The memory system may also access the previously-stored activate command 310-d from the buffer of the memory bank 340-b and perform an activate operation on the second row of the memory bank 340-a. For example, after performing the precharge operation associated with the precharge command 305-b on the second row of the memory bank 340-b, the memory system may determine that the next command in the command sequence (e.g., the command following the precharge command 305-b) may be the activate command 310-d. In response to determining the next command in the sequence of commands, and that the memory bank 340-b may be available, the memory system may trigger the accessing of the activate command 310-d from the buffer of the memory bank 340-b. The memory system may perform one or more activation operations on the memory bank 340-b. For example, after accessing the activate command 310-d stored to the buffer of the memory bank 340-b, the memory system may utilize the activate command 310-d to perform an activation operation on the second row of the memory bank 340-b.

The memory system may also receive the read command 315-c for the second row of the memory bank 340-a. For example, the memory system may receive the read command 315-c for the second row of the memory bank 340-a. The memory system may determine the second row of the memory bank 340-a to be available and active (e.g., after performing the activation operation associated with the activate command 310-c), and may perform a read operation on the second row of the memory bank 340-a according to the read command 315-c. The memory system may output the data 320-c from the second row of the memory bank 340-a via the DQ channel 325.

The memory system may receive another precharge command 305. For example, the memory system may receive a precharge command 305-c associated with the first row of the memory bank 340-a. In response to determining that the memory bank 340-a may be available, the memory system may perform a precharge operation associated with the first row of the memory bank 340-a according to the precharge command 305-c.

The memory system may receive the read command 315-d for the second row of the memory bank 340-b. For example, the memory system may receive the read command 315-d for the second row of the memory bank 340-b. The memory system may determine the second row of the memory bank 340-b to be available and active (e.g., after performing the activation operation associated with the activate command 310-d), and may perform a read operation on the second row of the memory bank 340-b according to the read command 315-d. The memory system may output the data 320-d from the second row of the memory bank 340-b via the DQ channel 325.

The memory system may receive another precharge command 305 via the CA channels 330. For example, the memory system may receive a precharge command 305-d associated with the first row of the memory bank 340-b. In response to determining that the memory bank 340-b may be available, the memory system may perform a precharge operation associated with the first row of the memory bank 340-b according to the precharge command 305-d.

Storing commands received out of order relative to a command sequence may decrease latency and increase efficiency in both the memory system and the host system. For example, enabling the memory system to store an activate command that may be received prior to a precharge command (e.g., or a read command that may be received prior to a precharge and an activate command, or another combination of commands received in an order different from the command sequence) may allow the memory system (e.g., or a memory controller thereof) to have more control over operations associated with the associated memory banks 340, rather than forcing the memory system to wait for the host system to send (e.g., or resend) the next command in the sequence of commands. Buffers at the memory-bank level may allow the memory system to queue received commands, which may decrease latency, as well as decrease cycles of time in between commands, which may increase power efficiency in the memory system.

The timing for data on the DQ channels 325 may be relative to a sequence of commands that are received on the CA channels 330, or stored commands. For example, where a read command 315 is received when a row is open, a first timing T₁ 335-a may be observed between the read command 315 and the data being available on the DQ channels 325. However, where a read command 315 is received prior to a row being open, a second timing T₂ 335-b may be observed, where the second timing T₂ 335-b may be dependent on completion of other (e.g., buffered) operations. For example, the second timing T₂ 335-b may be determined according to a last operation that is performed upon receipt of the command, with additional time provided for the buffered operations.

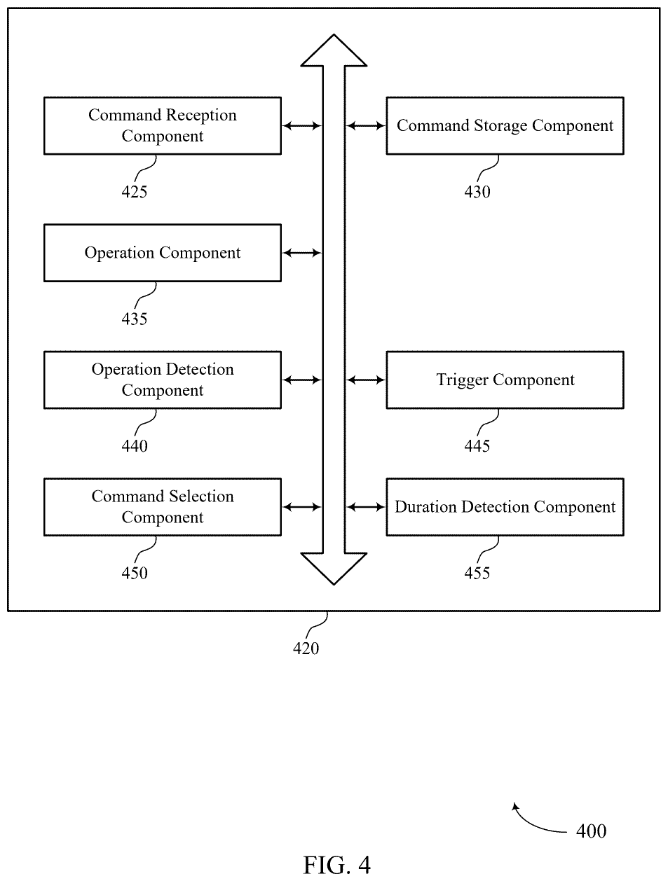

FIG. 4 shows a block diagram 400 of a memory system 420 that supports memory bank buffering of commands in accordance with examples as disclosed herein. The memory system 420 may be an example of aspects of a memory system as described with reference to FIGS. 1 through 3. The memory system 420, or various components thereof, may be an example of means for performing various aspects of memory bank buffering of commands as described herein. For example, the memory system 420 may include a command reception component 425, a command storage component 430, an operation component 435, an operation detection component 440, a trigger component 445, a command selection component 450, a duration detection component 455, or any combination thereof. Each of these components, or components of subcomponents thereof (e.g., one or more processors, one or more memories), may communicate, directly or indirectly, with one another (e.g., via one or more buses).

The command reception component 425 may be configured as or otherwise support a means for receiving a first command at a memory device including one or more memory banks, where the first command is associated with a memory bank of the one or more memory banks. The command storage component 430 may be configured as or otherwise support a means for storing the first command in a buffer associated with the memory bank based at least in part on receiving the first command. In some examples, the command reception component 425 may be configured as or otherwise support a means for receiving a second command at the memory device subsequent to receiving the first command, the second command associated with the memory bank. The operation component 435 may be configured as or otherwise support a means for performing a first operation associated with the second command. In some examples, the command storage component 430 may be configured as or otherwise support a means for accessing the first command from the buffer based at least in part on performing the first operation and a command sequence. In some examples, the operation component 435 may be configured as or otherwise support a means for performing a second operation associated with the first command based at least in part on accessing the first command from the buffer.

In some examples, the operation detection component 440 may be configured as or otherwise support a means for determining whether the first operation is complete. In some examples, the trigger component 445 may be configured as or otherwise support a means for triggering the accessing of the first command from the buffer in response to determining that the first operation is complete.

In some examples, to support accessing the first command from the buffer, the command selection component 450 may be configured as or otherwise support a means for selecting the first command from one or more commands stored to the buffer.

In some examples, the command reception component 425 may be configured as or otherwise support a means for receiving a third command at the memory device subsequent to receiving the second command, the third command associated with the memory bank. In some examples, the operation component 435 may be configured as or otherwise support a means for performing a third operation associated with the third command based at least in part on performing the second operation, where the third operation includes a read operation.

In some examples, a timing for output of data from the memory device for the read operation is based at least in part on a time for completion of the first operation and a time duration of the second operation.

In some examples, the first command includes an activate command associated with the memory bank and the second command includes a precharge command associated with the memory bank.

In some examples, to support performing the second operation, the duration detection component 455 may be configured as or otherwise support a means for determining a time duration associated with performing the first operation. In some examples, to support performing the second operation, the operation component 435 may be configured as or otherwise support a means for performing the second operation based at least in part on the determined duration and the command sequence.

In some examples, the memory device includes a plurality of memory banks and a plurality of buffers. In some examples, the plurality of memory banks are associated with respective buffers of the plurality of buffers.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

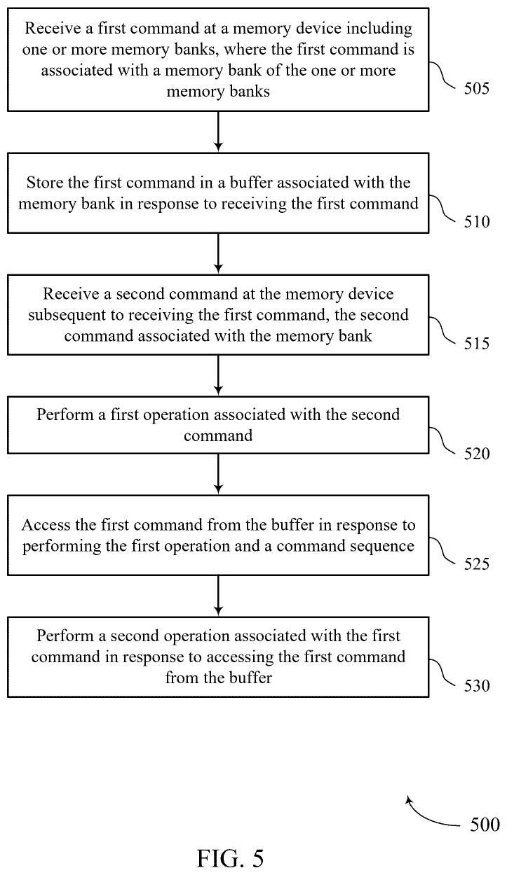

FIG. 5 shows a flowchart illustrating a method 500 that supports memory bank buffering of commands in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving a first command at a memory device including one or more memory banks, where the first command is associated with a memory bank of the one or more memory banks. In some examples, aspects of the operations of 505 may be performed by a command reception component 425 as described with reference to FIG. 4.

At 510, the method may include storing the first command in a buffer associated with the memory bank based at least in part on receiving the first command. In some examples, aspects of the operations of 510 may be performed by a command storage component 430 as described with reference to FIG. 4.

At 515, the method may include receiving a second command at the memory device subsequent to receiving the first command, the second command associated with the memory bank. In some examples, aspects of the operations of 515 may be performed by a command reception component 425 as described with reference to FIG. 4.

At 520, the method may include performing a first operation associated with the second command. In some examples, aspects of the operations of 520 may be performed by an operation component 435 as described with reference to FIG. 4.

At 525, the method may include accessing the first command from the buffer based at least in part on performing the first operation and a command sequence. In some examples, aspects of the operations of 525 may be performed by a command storage component 430 as described with reference to FIG. 4.

At 530, the method may include performing a second operation associated with the first command based at least in part on accessing the first command from the buffer. In some examples, aspects of the operations of 530 may be performed by an operation component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a first command at a memory device including one or more memory banks, where the first command is associated with a memory bank of the one or more memory banks; storing the first command in a buffer associated with the memory bank based at least in part on receiving the first command; receiving a second command at the memory device subsequent to receiving the first command, the second command associated with the memory bank; performing a first operation associated with the second command; accessing the first command from the buffer based at least in part on performing the first operation and a command sequence; and performing a second operation associated with the first command based at least in part on accessing the first command from the buffer.

Aspect 2: The method, apparatus, or non-transitory computer-readable medium of aspect 1, further including operations, features, circuitry, logic, means, or instructions, or any combination thereof for determining whether the first operation is complete and triggering the accessing of the first command from the buffer in response to determining that the first operation is complete.

Aspect 3: The method, apparatus, or non-transitory computer-readable medium of any of aspects 1 through 2, where accessing the first command from the buffer includes operations, features, circuitry, logic, means, or instructions, or any combination thereof for selecting the first command from one or more commands stored to the buffer.

Aspect 4: The method, apparatus, or non-transitory computer-readable medium of any of aspects 1 through 3, further including operations, features, circuitry, logic, means, or instructions, or any combination thereof for receiving a third command at the memory device subsequent to receiving the second command, the third command associated with the memory bank and performing a third operation associated with the third command based at least in part on performing the second operation, where the third operation includes a read operation.

Aspect 5: The method, apparatus, or non-transitory computer-readable medium of aspect 4, where a timing for output of data from the memory device for the read operation is based at least in part on a time for completion of the first operation and a time duration of the second operation.

Aspect 6: The method, apparatus, or non-transitory computer-readable medium of any of aspects 1 through 5, where the first command includes an activate command associated with the memory bank and the second command includes a precharge command associated with the memory bank.

Aspect 7: The method, apparatus, or non-transitory computer-readable medium of any of aspects 1 through 6, where performing the second operation includes operations, features, circuitry, logic, means, or instructions, or any combination thereof for determining a time duration associated with performing the first operation and performing the second operation based at least in part on the determined duration and the command sequence.

Aspect 8: The method, apparatus, or non-transitory computer-readable medium of any of aspects 1 through 7, where the memory device includes a plurality of memory banks and a plurality of buffers and the plurality of memory banks are associated with respective buffers of the plurality of buffers.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorous, boron, or arsenic.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory device, comprising:
one or more memory devices comprising one or more memory banks;
one or more buffers, wherein each memory bank of the one or more memory banks comprises a buffer of the one or more buffers; and
processing circuitry coupled with the one or more memory devices and configured to cause the memory device to:
receive a first command at the memory device;
store the first command in a buffer of the one or more buffers associated with a memory bank of the one or more memory banks in response to receiving the first command;
receive a second command at the memory device subsequent to receiving the first command, the second command associated with the memory bank;
perform a first operation associated with the second command;
access the first command from the buffer in response to performing the first operation and a command sequence; and
perform a second operation associated with the first command based in response to accessing the first command from the buffer.

2. The memory device of claim 1, wherein the processing circuitry is further configured to cause the memory device to:
determine whether the first operation is complete; and
trigger the accessing of the first command from the buffer in response to determining that the first operation is complete.

3. The memory device of claim 1, wherein accessing the first command from the buffer comprises the processing circuitry configured to cause the memory device to:
select the first command from one or more commands stored to the buffer.

4. The memory device of claim 1, wherein the processing circuitry is further configured to cause the memory device to:
receive a third command at the memory device subsequent to receiving the second command, the third command associated with the memory bank; and
perform a third operation associated with the third command based at least in part on performing the second operation, wherein the third operation comprises a read operation.

5. The memory device of claim 4, wherein a timing for output of data from the memory device for the read operation is in accordance with a time for completion of the first operation and a time duration of the second operation.

6. The memory device of claim 1, wherein the first command comprises an activate command associated with the memory bank and the second command comprises a precharge command associated with the memory bank.

7. The memory device of claim 1, wherein performing the second operation comprises the processing circuitry configured to cause the memory device to:
determine a duration associated with performing the first operation; and
perform the second operation in response to the determined duration and the command sequence.

8. A method, comprising:
receiving a first command at a memory device comprising one or more memory banks, wherein the first command is associated with a memory bank of the one or more memory banks;
storing the first command in a buffer associated with the memory bank in response to receiving the first command;
receiving a second command at the memory device subsequent to receiving the first command, the second command associated with the memory bank;
performing a first operation associated with the second command;
accessing the first command from the buffer in response to performing the first operation and a command sequence; and
performing a second operation associated with the first command in response to accessing the first command from the buffer.

9. The method of claim 8, further comprising:
determining whether the first operation is complete; and
triggering the accessing of the first command from the buffer in response to determining that the first operation is complete.

10. The method of claim 8, wherein accessing the first command from the buffer comprises:
selecting the first command from one or more commands stored to the buffer.

11. The method of claim 8, further comprising:
receiving a third command at the memory device subsequent to receiving the second command, the third command associated with the memory bank; and
performing a third operation associated with the third command in response to performing the second operation, wherein the third operation comprises a read operation.

12. The method of claim 11, wherein a timing for output of data from the memory device for the read operation is in accordance with a time for completion of the first operation and a time duration of the second operation.

13. The method of claim 8, wherein the first command comprises an activate command associated with the memory bank and the second command comprises a precharge command associated with the memory bank.

14. The method of claim 8, wherein performing the second operation comprises:
determining a time duration associated with performing the first operation; and
performing the second operation in accordance with the determined duration and the command sequence.

15. The method of claim 8, wherein:
the memory device comprises a plurality of memory banks and a plurality of buffers, and
the plurality of memory banks are associated with respective buffers of the plurality of buffers.

16. A non-transitory computer-readable medium storing code, the code comprising instructions executable by one or more processors to:
receive a first command at a memory device, the memory device comprising one or more memory banks, wherein the first command is associated with a memory bank of the one or more memory banks;
store the first command in a buffer associated with the memory bank in response to receiving the first command;
receive a second command at the memory device subsequent to receiving the first command, the second command associated with the memory bank;
perform a first operation associated with the second command;
access the first command from the buffer in response to performing the first operation and a command sequence; and
perform a second operation associated with the first command in response to accessing the first command from the buffer.

17. The non-transitory computer-readable medium of claim 16, wherein the instructions are further executable by the one or more processors to:
determine whether the first operation is complete; and
trigger the accessing of the first command from the buffer in response to determining that the first operation is complete.

18. The non-transitory computer-readable medium of claim 16, wherein the instructions to access the first command from the buffer are executable by the one or more processors to:
select the first command from one or more commands stored to the buffer.

19. The non-transitory computer-readable medium of claim 16, wherein the instructions are further executable by the one or more processors to:
receive a third command at the memory device subsequent to receiving the second command, the third command associated with the memory bank; and
perform a third operation associated with the third command in response to performing the second operation, wherein the third operation comprises a read operation.

20. The non-transitory computer-readable medium of claim 19, wherein a timing for output of data from the memory device for the read operation is in accordance with a time for completion of the first operation and a time duration of the second operation.

21. The non-transitory computer-readable medium of claim 16, wherein the first command comprises an activate command associated with the memory bank and the second command comprises a precharge command associated with the memory bank.

22. The non-transitory computer-readable medium of claim 16, wherein the instructions to perform the second operation are executable by the one or more processors to:
determine a duration associated with performing the first operation; and
perform the second operation in accordance with the determined duration and the command sequence.

23. The non-transitory computer-readable medium of claim 16, wherein:
the memory device is associated with one or more buffers, and
each of the one or more memory banks is associated with one of the one or more buffers.
